(19) United States
(12) Patent Application Publication
(10) Pub. No.: US 2003/0203083 A1
(43) Pub. Date: Oct. 30, 2003

(54) Method and device for dosing, dissolving and spraying enzymes on solid feed products products

(76) Inventors: Wolfgang Heinzl, Wachenheim (DE); Jorg Braun, Offenbach (DE); Roland Betz, Niederkirchen (DE); Barton Cousins, Bohl-Iggelheim (DE); Hans-Peter Harz, Dudenhofen (DE); Ulrich Heindl, Lantau Island (HK)

Correspondence Address: KEIL & WEINKAUF, 1350 CONNECTICUT AVENUE, N.W., WASHINGTON, DC, 20036, US

(21) Appl. No.: 10/381,373

(22) PCT Filed: Sep. 25, 2001
(86) PCT No.: PCT/EP01/11077

(30) Foreign Application Priority Data
Sep. 29, 2000 (DE) 100 48 385.2

(51) Int. Cl. A23B 4/00

(52) U.S. Cl. 426/302

(57) ABSTRACT

The invention relates to a process and the associated apparatus for metering and dissolving pulverulent enzymes and applying them to solid feed products. The apparatus comprises the following main components: a metering unit for pulverulent enzymes (I), a liquid reservoir unit (II), a mixing unit (III), a metering unit of the enzyme-containing liquid (IV) and an application apparatus (V). The individual main components are linked to one another by various connection units and are connected to a computer unit (22) which controls not only the operation of the individual main components but also their nteracti

The present invention relates to a process and apparatus for metering and dissolving enzymes and spraying them onto solid feed products.

Animals receive their feed administered predominantly either in pulverulent form (meal) or in cube form (pellets). Currently animal feed generally also comprises enzymes as feed constituent. In the case of pulverulent feed, enzymes are also added in this form. Some animal species, for example pigs, prefer, in contrast, their feed in pelleted form. Enzymes in powder form, however, do not adhere to pelleted feed, in addition the feed undergoes temperatures in the range of approximately 80° C. and above during the pelleting process, as a result of which, inter alia, salmonellae and E. coli bacteria are made harmless. Any enzymes added would also be destroyed at these temperatures or their activity would at least be greatly impaired. For this reason, the enzymes are only applied subsequently to the pelleting process after the mixed feed has cooled. This process has long been known as post pelleting application (PPA), the enzymes having to be applied in liquid form to the feed products in order to achieve improved distribution over, and adhesion to, the feed pellets.

In the feedstuffs industry it is customary practice that the enzymes used are delivered already in dissolved form as concentrate and are diluted on site to the desired concentration. The dissolved enzymes are then sprayed onto the pelleted feed products via a special apparatus. The complex process of manual dissolution and dilution of the pulverulent enzymes to the desired final concentration is also possible. For this reason it is of interest to develop apparatuses which make the metering, dissolution and spraying of pulverulent enzymes onto solid feed products possible in one working step. This also has the advantage that it gives rise to lower transport costs, since the transport volume of customary pulverulent enzymes is generally smaller by a factor of 5 than the volumes of the corresponding enzyme concentrate solutions which are currently used in PPA. In addition, in this process, the problem of the storage life of aqueous enzyme concentrate solutions during transport and storage over a relatively long period must no longer be taken into account. This is advantageous, in particular, if the PPA is to be carried out in (very) hot regions.

U.S. Pat. No. 6,056,822 also describes, inter alia, a computer-aided apparatus in which the pulverulent enzymes are transferred from a reservoir to a mixing vessel in order to be dissolved there using an agitator with addition of a liquid, and metered. The enzyme solution is then distributed to two tanks, in order to be applied from there, alternately, via a spray apparatus to pelleted feed products. However, a number of disadvantages are associated with this apparatus. The enzymes are dissolved with the aid of an agitator, liquid can only be introduced from one individual container into the mixing vessel, in addition, two containers are necessary for intermediate storage of the finished enzyme solution.

It is an object of the present invention to eliminate the obvious defects associated with the prior art, by further optimizing the time-consuming and costly process and the associated apparatus for metering and dissolving pulverulent enzymes and applying them to solid feed products.

We have found that this object is achieved by a process and the apparatus underlying the process which have the following features:

a) Via a line and a port, one liquid is transferred into a mixing vessel,

b) enzymes in powder form are then transferred from a metering hopper into the mixing vessel and dissolved in the previously added liquid,

c) a second liquid is pumped from a further reservoir vessel by a pump into the mixing vessel, the liquids being introduced separately or together into the mixing vessel using one port,

d) the contents of the mixing vessel, to homogenize the solution, are pumped by means of a pump at freely settable time intervals through a circuit which essentially comprises

(d1) a mixing vessel,

(d2) a pump,

(d3) a valve,

(d4) an introduction apparatus situated within the interior of the mixing vessel, on which are mounted one or more ports,

(d5) and a line which can be attached to the mixing vessel at various points, the one end of the line being connected to the bottom of the mixing vessel and the other end being connected to the introduction apparatus, whereupon

e) the contents of the mixing vessel are transferred into a metering vessel, from which

f) the contents of the metering vessel are passed on into one or more parallel metering units, in order from there finally to be applied to the solid feed products.

The advantages of the inventive solution are, in particular, that, firstly, owing to the presence of a plurality of ports which are variable in their positioning, and which are, in particular, nozzles, in the mixing vessel an agitator and the associated servodrive can be dispensed with, which causes considerable savings in the space and costs. In addition, the respective concentration of the enzyme solutions can be set more precisely, since any solids deposits on the housing internal wall of the mixing vessel can be added back much more effectively to the enzyme solution by this variably positionable spraying technique than with an agitator, this applies in particular if relatively small amounts of liquid remain in the mixing vessel and, due to the agitating action, only a small portion of the housing internal wall may be covered with liquid.

A further advantage of the inventive solution is that there is the possibility of adding at least two liquids independently of one another to the solution of the pulverulent enzymes. As a result, if appropriate, different concentrations of the second or any other liquid in the mixing vessel may be set.

A further advantage of the inventive solution is that only one container is necessary for intermediate storage of the finished enzyme solution. Apparatuses according to the prior art, however, require two such containers which additionally require a complex system of valves, pumps, circulation lines and return lines. In contrast, by means of the inventive apparatus, cost savings and space savings may be made significantly in the fabrication of the apparatus and also the operation, monitoring and servicing of the apparatus is considerably simplified.

An additional advantage of the inventive solution is the parallel disposition of a plurality of metering units for applying the enzyme solution to the solid feed products. As a result, a plurality of batches of solid feed products can be simultaneously operated and given differing dosages.

On the basis of the drawing, the invention is described in more detail.

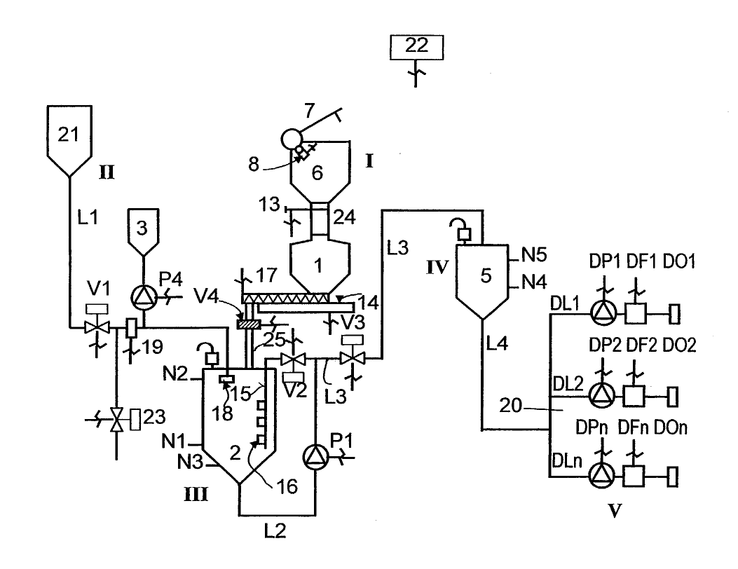

From FIG. 1 it can be seen that the inventive apparatus for metering and dissolving the pulverulent enzymes and applying them to solid feed products comprises the following main components: a metering unit for pulverulent enzymes I, a liquid reservoir unit II, a mixing unit III, a metering unit of the enzyme-containing liquid IV and an application apparatus V. The individual main components are linked to one another by to various connection units and are connected to a computer unit 22 which controls not only the operation of the individual main components but also their interaction.

The metering unit for pulverulent enzymes I comprises a metering hopper 1 on which is mounted a reservoir hopper 6. Between the reservoir hopper 6 and the metering hopper 1 is situated a, for example, pneumatic valve 13 and a connection piece 24 which, in a preferred embodiment of the inventive apparatus, is made flexible entirely or in certain regions. A lid 7 is mounted on the reservoir hopper 6. In a preferred construction of the inventive apparatus, the lid 7 is a rotating or tilting lid having a lock 12 which can be actuated electromagnetically, in which case, when the lid 7 is closed, the lug 10 of a microswitch 8 folds into the groove of a small wheel 9 which is mounted on the underneath of the lid 7. The metering hopper 1 is on a balance 14, the lower side of the metering hopper 1 is connected to a metering auger 17, which is followed in turn by a valve V4. By means of the balance 14, the weight of the components situated in the metering hopper 1 can be determined.

The microswitch 8, the valve 13, the balance 14, the metering auger 17 and the valve V4 are controlled by a computer unit 22 which is also connected via a light pen 11. The microswitch 8, the valve 13, the metering auger 17 and the valve V4 are each additionally provided with servodrives which are familiar to those skilled in the art, in particular electric servodrives for the microswitch 8, the metering auger 17 and the valve V4, and a pneumatic servodrive for the valve 13.

The liquid reservoir unit II comprises a reservoir vessel 21 which is connected to a line L1 which has a valve V1, preferably a solenoid valve, as an intermediate connection. The reservoir vessel 21 is either a tank or some other container which is suitable for holding a liquid F1. The liquid F1 is in particular water. Following the valve V1 a flow meter 19 is connected into the line L1, which flow meter is connected to the computer unit 22. The line L1 can additionally be connected via an intermediate valve 23, which is preferably a solenoid valve, to an external liquid reservoir, for example a water line. This branch of the line L1 is, if appropriate, between the valve V1 and the flow meter 19. In addition, the liquid reservoir unit II comprises a reservoir vessel 3 which is also connected to the line L1 via a pump P4. The reservoir vessel 3 serves for holding a liquid F2, in particular for holding liquid or dissolved stabilizers. This can be either an individual stabilizer or else a mixture of a plurality of stabilizers.

The valve V1 and the pump P4 are controlled by the computer unit 22, and both each have an electric servodrive. If appropriate, the valve 23 can also be controlled by the computer unit 22 and be provided with an electric servodrive.

In an additional embodiment of the inventive apparatus, the liquid reservoir unit II comprises other reservoir vessels conforming to reservoir vessel 3, which are each connected via an intermediate pump to the line L1.

In a further embodiment of the inventive apparatus, a container for the liquid F1 is dispensed with. The line L1 in this case is connected via the valve 23 to an external liquid source, for example a water line or a line which leads to a liquid reservoir vessel which is situated externally of the inventive apparatus. Also, an apparatus can be designed, the liquid reservoir unit II of which does not comprise a reservoir vessel 3 with associated pump P4.

The mixing unit III comprises a mixing vessel 2 whose upper side is connected via a connection piece 25 to the valve V4, a component of the metering unit for pulverulent enzymes I. In this manner, pulverulent enzymes from the metering hopper 1 pass into the mixing vessel 2. In a preferred embodiment of the inventive apparatus, the connection piece 25 is made flexible in whole or in certain regions. In addition the line L1, a component of the liquid reservoir unit II opens into the upper side of the mixing vessel 2. In the interior of the mixing vessel 2 the line L1 finishes at a port 18, the purpose of which is to distribute the liquid exiting from the line L1, which originates from the liquid reservoir unit II, over a large area in the housing of the mixing vessel 2. Preferably, as port 18, one or more nozzles which are linked to one another are used, particularly preferably one or more rotating nozzles which are linked to one another, which can be provided with an electric servodrive and can be controlled by the computer unit 22. In addition, in the interior of the mixing vessel 2, three variable-position level gauges are mounted to determine the liquid volume found in the mixing vessel 2, which are each connected to the computer unit 22. On the lower side of the mixing vessel 2 a line L2 exits, into which line are connected a pump P1 and a valve V2 which is in particular a solenoid valve. At the other end, the line L2 is connected to an inlet apparatus 15 which can be introduced into the interior of the mixing vessel 2 at various positions provided for this, the line L2 being made flexible in whole or in certain regions.

Suitable apparatuses for the inlet apparatus 15 are all apparatuses which are conceivable therefor, in particular, however, lance-shaped inlet apparatuses. In a particularly preferred embodiment, these are rotating inlet apparatuses which can be driven via an electric servodrive. On these inlet apparatuses are mounted one or more ports 16, preferably nozzles, which in turn can also be rotating and, if appropriate, can be driven via an electric servodrive. The mixing vessel 2, the pump P1, the valve V2, the line L1, the inlet apparatus 15 and the port 16 form a circuit 4, which acts for mixing and solution homogenization of the components situated in the mixing vessel 2. The ports 16 and 18, cause, inter alia, the liquid exiting therefrom to be distributed over a large area over the housing internal wall of the mixing vessel 2, in order to wash off from the internal wall any enzyme appearing on the internal wall which was transferred from the metering hopper 1 via the metering auger 17, the valve V4 and the connecting piece 24 into the mixing vessel 2, and to recirculate it to the solution process.

The valve V2 and the pump P1 are also controlled by the computer unit 22, and the valve V2 and the pump P1 are each provided with an electric servodrive.

The metering unit of the enzyme-containing liquid IV comprises a metering vessel 5, into the upper part of which opens a line L3 into which are connected a valve V3, which is preferably a solenoid valve, and which branches off at a suitable point from the line L2. The contents of the mixing vessel 2 are transferred to the metering vessel 5 via the lines L2 and L3. Within the metering vessel 5 are mounted two variable-position level indicators which serve to determine the liquid volume found in the metering vessel 5 and are each connected to the computer unit 22. A line L4 is mounted at the lower side of the metering vessel 5. The valve V3 is also controlled by the computer unit 22 and is additionally provided with an electric servodrive.

The application apparatus V comprises the line L4 to which are connected one or more parallel metering units 20 each of which essentially comprise a metering pump DP, a flow meter DF, one or more ports DO and the associated lines DL. The ports DO are situated here at the end of the respective line DL and are mounted in such a manner that the liquid exiting from the line DL is applied to the solid feed products transported past the ports. In a preferred form of the inventive apparatus, the liquid exiting from the ports DO is sprayed or injected onto the feed products. The ports DO are preferably nozzles, particularly preferably rotating nozzles. In order to distribute the liquid exiting from the ports DO more finely over the solid feed products, the exiting liquid can additionally be admixed with gases, for example air. Special apparatuses of this type for introducing gases into liquids are as well known to those skilled in the art as the special transport apparatuses for solid feed products and are therefore not described hereafter in more detail. The use of a plurality of parallel metering units has the advantage that a plurality of transport apparatuses which are below the corresponding metering apparatuses, and also in parallel can be served, whereby a relatively large amount and possibly different types of solid feed products can be treated separately from one another and at the same time with dissolved enzymes. By controlling the corresponding metering pumps DP, different liquid volumes per unit time can be applied from the appropriate ports onto the solid mixed feed products.

The metering pumps DP, the flow meters DF and, if appropriate, the ports DO are also controlled by the computer unit 22 and each are additionally provided with an electric servodrive.

The interaction controlled via the computer unit 22 of the individual components of the inventive apparatus among one another is to be described in more detail below with reference to a possible example. First, the pulverulent enzymes are charged into the reservoir hopper 6, for which the lid 7 must be opened. The lid 7 may only be opened when the valve 13 is closed and the pulverulent enzyme barcode which is applied to the respective packaging unit and is read with the light pen 11 agrees with a barcode which has been read in previously into the computer unit 22 and stored there. This safety precaution reduces the risk of charging the wrong solids.

The contents of the reservoir vessel 6 are transferred completely or partially into the metering hopper 1 by opening the valve 13. The valve 13 can only be opened if (a) the amount of component in the interior of the metering hopper 1 which is determined by the balance 14 has fallen below a weight G1 set in the computer unit 22, (b) the metering auger 17 is not in operation and (c) the lid 7 is closed. If the amount of component situated within the interior of the metering hopper 1, which is determined by the balance 14, has fallen below a weight G1 set in the computer unit 22, the computer unit 22, if appropriate, controls the opening of the valve 13. When the amount of component situated within the interior of the metering hopper 1, which is determined by the balance 14, reaches a weight G2 set in the computer unit 22, the valve 13 closes again. In the event that material cannot be charged up to the weight G2, the computer unit 22 produces at a suitable point the information that the reservoir hopper 6 must be replenished.

If in the interior of the mixing vessel 2 the liquid volume has fallen below a level determined by a level indicator having the value N1, the circuit 4 is put into operation. By control with the computer unit 22, the pump P1 is started and the valve V2 opened, after previously, if appropriate, the valve V3 was closed. In addition, the mixing vessel 2 is charged with a liquid originating from the liquid reservoir unit II up to a level determined by a second level indicator having the value N2. Addition of the liquid F1 originating from the liquid reservoir unit II is performed by computer-controlled opening of the valve V1, and the liquid volume to be added is measured by the flow meter 19. When, in the interior of the mixing vessel 2, a level determined by the second level indicator having the value N2 has been reached, the valve V1 is closed under computer control. By starting up the metering auger 17 and simultaneously opening the valve V4, an amount of the contents of the metering hopper 1, which is matched by the computer unit 22 to the level value N2, is transferred to the mixing vessel 2, whereupon the metering auger 17 is shut off and the valve V4 is closed. Any desired concentrations of enzyme solution can be set in the mixing vessel 2.

Subsequently thereto, if appropriate, a further liquid F2 can be added by computer-controlled activation of the pump P4. More preferably, the amount of added liquid F2 is controlled via a number of pump pulses of the pump P4 which is set in the computer unit 22, after which the pump P4 is shut off under computer control. The addition of liquid F2 can, if appropriate, also be performed simultaneously with the addition of liquid F1, in which the pump P4 is controlled similarly to that described above by the computer unit 22.

The circuit 4 remains active for solution homogenization for sufficiently long time intervals which are determined and controlled by the computer unit 22. Subsequently thereto, the pump P1 and the valve V2 are shut off and closed, respectively, under computer control.

When, in the interior of the mixing vessel 2, the liquid volume has fallen below a level determined by a third level indicator having the value N3, the computer unit 22 displays a warning at a suitable location.

If, in the metering vessel 5, the volume of the vessel contents has fallen below a level determined by a level indicator having the value N4, the contents of the mixing vessel 2 are transferred to the metering vessel 5 via the lines L2 and L3 down to a level having the value N5 which is determined by a further level indicator situated within the interior of the metering vessel 5. The computer unit 22, for this, initiates the opening of valve V3 and starts the pump P1. If, in the metering vessel 5, the level determined by the second level indicator having the value N5 is reached, the pump P1 and the valve V3 are shut off and closed, respectively, under computer control. The computer unit 22 cannot initiate charging of the metering vessel 5 until the circuit 4 associated with the mixing unit 3 is shut off. For this reason, the permitted highest levels and lowest levels of container contents of the mixing vessel 2 and the metering vessel 5 which are specified by the appropriate level indicator, and the minimum weight of contents of the metering hopper 1 determined by the balance 14 are matched with one another so as to prevent the respective other components from running empty.

The value N4 in the metering vessel 5 is set high enough so that a complete solution cycle, that is to say the replenishment of the metering hopper 1, liquid addition and enzyme addition into the mixing vessel 2 and the solution homogenization can be carried out without any problems by the circuit 4, without the metering vessel 5 running empty.

If the flow meters DF1 to DFn of the metering unit 20 no longer measure the amounts of flowing liquid specified in the computer unit 22, the computer unit 22 indicates a warning at a suitable position.

Furthermore, it must be stated that the computer unit 22 can also control the interaction of the individual apparatus components, in particular the steps relevant for the mixing unit III, in a manner deviating from the example above. The matching of the apparatus components participating in the individual process steps is carried out accordingly. The possibility of a time-staggered actuation of the circuit 4 and replenishment of the mixing vessel 2 with liquid from the liquid reservoir unit II and with solids from the metering unit for pulverulent enzymes I may be mentioned explicitly. The sequence of these three steps can be varied in any manner, if appropriate.

All of the system components of the inventive apparatus are designed in such a manner that, in addition to the computer-controlled standard operation, manual operation of the individual system components is also possible.

To clean the inventive apparatus, various apparatus components, in particular the metering hopper 1, the mixing vessel 2, the reservoir vessel 3 and the metering vessel 5, are provided at a suitable position with ports suitable therefor, which may be controlled by the computer unit 22 or manually.

Suitable enzymes are all customary enzymes which are used in the feedstuffs industry, in particular the enzymes Vitase and NSP (non starch polysaccharide). To dissolve these enzymes, preferably, pure water is used as liquid.

The inventive apparatus is particularly suitable for producing enzyme solutions and any admixture of liquid or dissolved additives, such as stabilizers, in a batch process, and the simultaneous application of these solutions onto one or more batches of solid feed products.

List of Designations

1 Metering hopper

2 Mixing vessel

3 Reservoir vessel

4 Circuit

5 Metering vessel

6 Reservoir

7 Lid

8 Microswitch

9 Wheel with small groove

10 Lug

11 Light pen

12 Lock

13 Valve

14 Balance

15 Inlet apparatus

16 Port

17 Metering anger

18 Port

19 Flow meter

20 Metering unit

21 Reservoir vessel

22 Control unit

23 Valve

24 Connection piece

25 Connection piece

L=Line

N=Level indicator

V=Valve

G=Weight

P=Pump

D=Metering . . .

F=Flow meter

O=Port

I Metering unit for pulverulent enzymes

II Liquid reservoir unit

III Mixing unit

IV Metering unit for the enzyme-containing liquid

V Application apparatus

We claim:

1. A process for metering and dissolving enzymes and applying them to solid feed products, which comprises
a) transferring a liquid (F1) via a line (L1) and a port (18) into a mixing vessel (2),
b) transferring enzymes in powder form from a metering hopper (1) into the mixing vessel (2) and dissolving them in the previously added liquid (F1),
c) pumping the contents of the mixing vessel (2), to homogenize the solution, by means of a pump (P1) in freely settable time intervals through a circuit (4) which essentially comprises
(c1) the mixing vessel (2),
(c2) the pump (P1),
(c3) a valve (V2),
(c4) an introduction apparatus (15) situated within the interior of the mixing vessel (2), on which are mounted one or more ports (16),
(c5) and a line (L2) which can be attached at various points to the mixing vessel (2), the one end of the line (L2) being connected to the bottom of the mixing vessel (2) and the other end being connected to the introduction apparatus (15), whereupon
d) the contents of the mixing vessel (2) being transferred into a metering vessel (5), from which
e) the contents of the metering vessel (5) are passed on into one or more parallel metering units (20) in order from there finally to be applied to the solid feed products.

2. A process as claimed in claim 1, wherein the contents of the mixing vessel (2) are not completely transferred to the metering vessel (5).

3. A process as claimed in claims 1 or 2, wherein the dissolved enzymes are applied to the pelleted feed products.

4. A process as claimed in one of claims 1 to 3, wherein the liquid (F1) is preferably water.

5. A process as claimed in one of claims 1 to 4, wherein the dissolved enzymes are sprayed or injected onto the solid feed product.

6. A process as claimed in one of claims 1 to 5, wherein the circuit (4) for homogenizing the contents of the mixing vessel (2) can be switched on at any desired time points and for freely settable time intervals by starting the pump (P2).

7. A process as claimed in one of claims 1 to 6, wherein
a) via a line (L1) and a port (18) one liquid (F1) is transferred into a mixing vessel (2),
b) enzymes in powder form are transferred from a metering hopper (1) into the mixing vessel (2) and are dissolved in the previously added liquid (F1),
c) a second liquid (F2) is pumped from a further reservoir vessel (3) by a pump (P4) into the mixing vessel (2), the liquids (F1) and (F2) being introduced separately or together into the mixing vessel (2) using one port (18),
d) the contents of the mixing vessel (2), to homogenize the solution, are pumped by means of a pump (P1) in freely settable time intervals through a circuit (4) which essentially comprises
(d1) the mixing vessel (2),
(d2) the pump (P1),
(d3) a valve (V2),
(d4) an introduction apparatus (15) situated within the interior of the mixing vessel (2), on which are mounted one or more ports (16),
(d5) and a line (L2) which can be connected to the mixing vessel (2) at various points, the one end of the line (L2) being connected to the bottom of the mixing vessel (2) and the other end being connected to the introduction apparatus (15), whereupon
e) the contents of the mixing vessel (2) are transferred into a measuring vessel (5), from which
f) the contents of the metering vessel (5) are passed on into one or more parallel metering units (20), in order from there finally to be applied to the solid feed products.

8. A process as claimed in claim 7, wherein the liquid (F2) is preferably one or more liquid or dissolved stabilizers.

9. A computer-aided apparatus as claimed in one of claims 1 to 8, wherein
a) via a line (L1) and a port (18) a liquid (F1) is transferred into a mixing vessel (2),
b) enzymes in powder form are transferred from a metering hopper (1) into the mixing vessel (2) and dissolved in the previously added liquid (F1),
c) a second liquid (F2) is pumped from a further reservoir vessel (3) by a pump (P4) into the mixing vessel (2), the liquids (F1) and (F2) being introduced (2) separately or together into the mixing vessel using the port (18),
d) the contents of the mixing vessel (2), to homogenize the solution, are pumped by means of a pump (P1) in freely settable time intervals through a circuit (4) which essentially comprises
(d1) the mixing vessel (2)
(d2) the pump (P1),
(d3) a valve (V2),
(d4) an introduction apparatus (15) situated within the interior of the mixing vessel (2), on which are mounted one or more ports (16),
(d5) and a line (L2) which can be attached to the mixing vessel (2) at various points, the one end of the line (L2) being connected to the bottom of the mixing vessel (2) and the other end being connected to the introduction apparatus (15), whereupon,
e) the contents of the mixing vessel (2) are transferred into a metering vessel (5), from which
f) the contents of the metering vessel (5) are passed on into one or more parallel metering units (20), in order from there finally to be applied to the solid feed products.

10. A computer-aided apparatus as claimed in claim 9, wherein the metering hopper (1) is mounted on a balance (14) and is connected via a connection piece (24) to a reservoir hopper (6), a valve (13) being situated between the metering hopper (1) and the reservoir hopper (6).

11. Computer-aided apparatus as claimed in claim 9 or 10, wherein, as soon as the liquid volume in the mixing vessel (2) has fallen below a level determined by a level indicator having the value (N1), a liquid (F1) is charged into the mixing vessel (2) by opening a valve (V1) via a line (L1) and a port (18) situated at the upper part of the housing internal wall of the mixing vessel (2) and the added liquid volume is metered by computer-aided control of the valve (V1) until, in the interior of the mixing vessel (2), the liquid volume has reached a level (N2) determined via a level indicator.

12. A computer-aided apparatus as claimed in claim 11, wherein the port (18) situated on the upper part of the housing internal wall of the mixing vessel (2) is a nozzle, in particular a rotating nozzle.

13. A computer-aided apparatus as claimed in one of claims 9 to 12, wherein an amount of pulverulent enzymes based on the level (N2) is transferred into the mixing vessel (2) from the metering hopper (1) via a connection piece (25) by starting the metering anger (17) and opening the valve (V4).

14. A computer-aided apparatus as claimed in one of claims 9 to 13, wherein the contents of the mixing vessel (2) are automatically transferred to the metering vessel (5) from the mixing vessel (2) via a pump (P1) via the lines (L2) and (L3) automatically by opening the valve (V3) and closing the valve (V2), if the level of the liquid volume in the metering vessel (5) which is determined by a level indicator has fallen below a value (N4) until the liquid volume reaches a level determined by a level indicator having the value (N5), whereupon the valve (V3) and the pump (P1) are automatically closed and shut off, respectively.

15. A computer-aided apparatus as claimed in one of claims 9 to 14, wherein the contents of the metering vessel (5) are automatically passed on via a line (L4) into one or more parallel metering units (20) for application to solid feed products. The metering units (20) each comprise
a) a metering pump (DP)
b) a flow meter (DF)
c) one or more ports (DO) and
d) the associated lines (DL).
